(19) United States
(12) Patent Application Publication
(10) Pub. No.: US 2004/0246198 A1
(43) Pub. Date: Dec. 9, 2004

(54) Electronic apparatus and display device power management method

(75) Inventor: Masaya Sahashi, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/828,255

(22) Filed: Apr. 21, 2004

(30) Foreign Application Priority Data
Jun. 3, 2003 (JP) 2003-158329

(51) Int. Cl. G09G 5/00

(52) U.S. Cl. 345/3.1; 345/1.1

(57) ABSTRACT

There is provided an electronic apparatus capable of displaying same data on a plurality of display devices. The electronic apparatus includes a setting unit which enables to individually set on a setting screen a wait time for turning off power to each of the plurality of display devices, and a power-off execution unit which turns off power to a display device, among the plurality of display devices, if a continuous time of a state in which connection/disconnection of each display device is unchanged reaches the wait time set for the display device.

### CROSS-REFERENCE TO RELATED APPLICATIONS

This application is based upon and claims the benefit of priority from prior Japanese Patent Application No. 2003-158329, filed Jun. 3, 2003, the entire contents of which are incorporated herein by reference.

### BACKGROUND OF THE INVENTION

1. Field of the Invention

The present invention relates to an electronic apparatus to which a plurality of display devices are connectable, and to a display device power management method of controlling power to each of the plurality of display devices.

2. Description of the Related Art

In recent years, an electronic apparatus such as a personal computer is configured to be connectable to a variety of display devices, depending on purposes of use. For example, the same data can be simultaneously displayed on a plurality of display devices including such external monitors as a digital video interface (DVI) monitor, a cathode ray tube (CRT) monitor and a television (TV) monitor, in addition to a liquid crystal display (LCD) monitor that is a built-in monitor of the electronic apparatus.

A considerable amount of power is consumed in the state in which such various display devices are turned on. To solve this problem, a power saving management utility is provided in the electronic apparatus, thereby to set a wait time for automatically turning off power supply to the display devices. If the state in which the user does not operate the input device has continued for a predetermined time period, the power supply to the display devices is automatically turned off.

Jpn. Pat. Appln. KOKAI Publication No. 2000-163035 discloses a technique wherein if a mouse pointer or an active window is not displayed on a specified monitor for a predetermined time period, the power supply mode of the monitor is switched to a low-power-consumption mode.

In this document, however, it is not possible to individually set the wait time for turning off power to each of the display devices. For example, such flexible setting, as described below, cannot be effected: a short wait time is set for a display device with a high power consumption, and a long wait time is set for a display device with a low power consumption.

In the above document, only the specified monitor can be transited to the low-power-consumption mode. However, the transition to the low-power-consumption mode is affected by the display condition of the mouse pointer or active window. For the user who does not desire such transition of mode, this technique is not convenient. Moreover, the technique of this document is not applicable to the case where the same data is simultaneously displayed on a plurality of display devices.

### BRIEF SUMMARY OF THE INVENTION

Embodiments of the present invention may provide an electronic apparatus and a display device power management method, which enable a user to individually set a wait time for turning off power supply to each of display devices.

According to one aspect of the present invention, there is provided an electronic apparatus capable of displaying same data on a plurality of display devices, comprising a setting unit which enables to individually set on a setting screen a wait time for turning off power to each of the plurality of display devices; and a power-off execution unit which turns off power to a display device, among the plurality of display devices, if a continuous time of a state in which connection/disconnection of each display device is unchanged reaches the wait time set for the display device.

According to another aspect of the present invention, there is provided a display device power management method applied to an electronic apparatus capable of displaying same data on a plurality of display devices, the method comprising enabling individual setting, on a setting screen, of a wait time for turning off power to each of the plurality of display devices; and turning off power to a display device, among the plurality of display devices, if a continuous time of a state in which connection/disconnection of each display device is unchanged reaches the wait time set for the display device.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of an electronic apparatus system according to an embodiment of the present invention;

FIG. 2 illustrates the functions of various software units relating to the control of each display device;

FIG. 3 illustrates information that is handled by a power saving management unit and a system BIOS; and

FIG. 4 is a flow chart illustrating the operation of the power saving management unit.

### DETAILED DESCRIPTION OF THE INVENTION

Embodiments of the present invention will be described below with reference to the drawings.

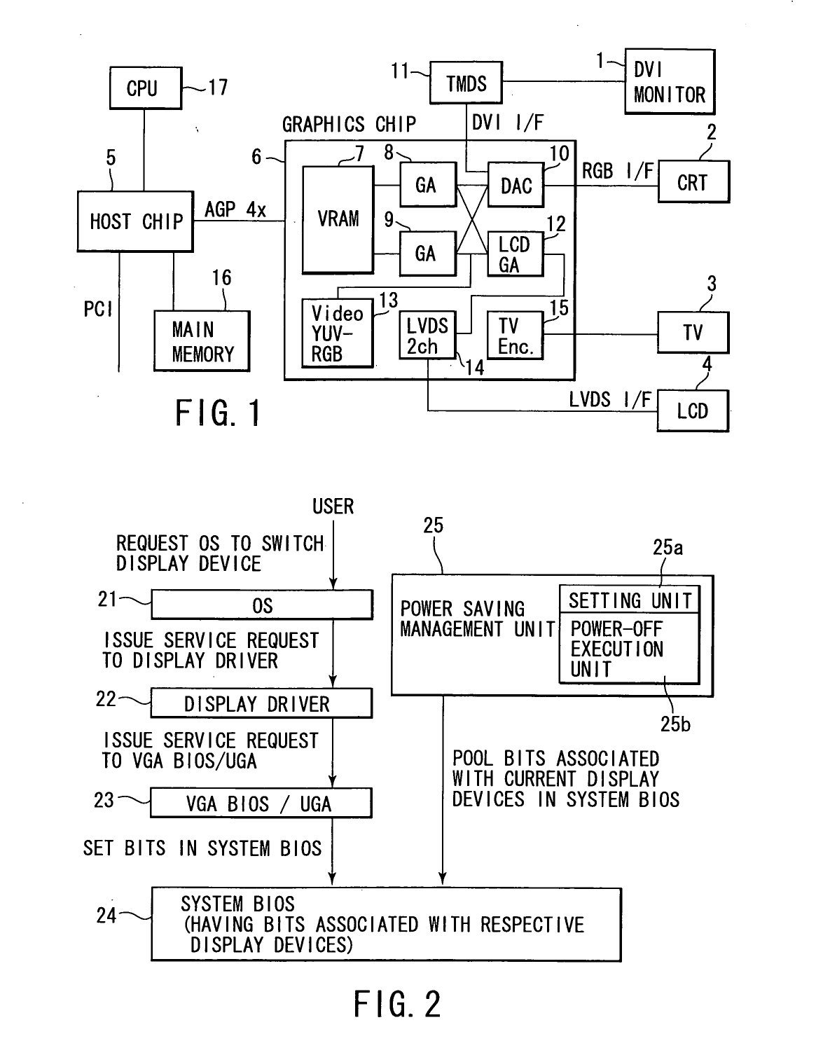

FIG. 1 is a block diagram showing the structure of an electronic apparatus system according to an embodiment of the present invention.

The electronic apparatus system is provided with such external monitors for an electronic apparatus (e.g., a personal computer) as a DVI monitor 1, a CRT monitor 2 and a TV monitor 3. The monitors 1 to 3 are detachably connectable to predetermined connectors of the electronic apparatus. In addition, an LCD monitor 4 is provided as a built-in monitor of the electronic apparatus.

The electronic apparatus includes a host chip 5, a graphics chip 6, a transition minimized differential signaling (TMDS) process unit 11, a main memory 16 and a CPU 17.

The graphics chip 6 is capable of simultaneously outputting the same data to the monitors 1 to 4. The graphics chip 6 includes a VRAM 7, two graphics accelerators (GA) 8, 9, a digital/analog converter (DAC) 10, an LCD-GA 12, a video YUV-RGB converter 13, an low voltage differential signaling (LVDS) process unit 14, and a TV encoder 15.

The DVI monitor 1 conforms to the DVI standard. The DVI monitor 1 is a display device that displays on the screen the data sent from the TMDS process unit 11.

The CRT monitor 2 conforms to the RGB interface. The CRT monitor 2 is a display device that displays on the screen the data sent from the DAC 10.

The TV monitor 3 is a display device that displays on the screen the data sent from the TV encoder 15.

The LCD monitor 4 conforms to the LVDS interface. The LCD monitor 4 is a display device that displays on the screen the data sent from the LVDS process unit 14.

The host chip 5 includes a controller for controlling the graphics chip and a controller for controlling the main memory 16. The host chip 5 performs a bridge process between the CPU 17 and other buses (including a PCI bus and a bus connected to a BIOS-ROM).

The graphics chip 6 executes data transmission/reception to/from the host chip 5 via an accelerated graphics port (AGP).

The VRAM 7 is a memory for storing data that is to be displayed on the display devices.

The GA 8 and GA 9 subject the data on the VRAM 7 to processing for high-speed, high-definition display, and output the processed data to the DAC 10 and LCD-GA 12.

The DAC 10 converts the digital data, which is sent from the GA 8 or GA 9 to RGB analog data, and outputs the converted data to the CRT monitor 2.

The TMDS process unit 11 receives the same signal as the signal input to the DAC 10, and subjects the received signal to TMCS processing. The TMCS-processed data is output to the DVI monitor 1.

The LCD-GA 12 processes the digital data sent from the GA 8 or GA 9 so as to conform to the LCD.

The video YUV-RGB converter 13 converts YUV data to RGB data.

The LVDS process unit 14 receives the data processed by the LCD-GA 12, and subjects the data to LVDS processing. The LVDS-processed data is output to the LCD monitor 4.

The TV encoder 15 encodes, e.g. a TV video signal, and outputs the encoded data to the TV monitor 3.

The main memory 16 stores the OS, various drivers (including display drivers), power saving management utility program, and applications. The main memory 16 is provided as a working area for the CPU 17.

FIG. 2 illustrates the functions of various software units relating to the control of each display device.

When the user has requested an OS 21 to switch a certain display device, the OS 21 issues a corresponding service request to a display driver 22.

Upon receiving the service request, the display driver 22 carries out the service request for a VGA-BIOS/UGA 23.

Upon receiving the service request from the display driver 22, the VGA-BIOS/UGA 23 sets the bit relating to the designated display device in a system BIOS 24.

The system BIOS 24 retains, as bits, various setting information (including information indicative of the state of connection of the display device to the electronic apparatus) relating to the display device designated by the user. In addition, each time the display device that is connected to the electronic apparatus is altered, the bits are changed.

On the other hand, a power saving management unit 25 is realized as the aforementioned power saving utility program. In particular, the power saving management unit 25 includes a setting unit 25a and a power-off execution unit 25b. The setting unit 25a is capable of individually setting on the setting screen the wait time for turning off the power to the plural display devices (DVI monitor 1, CRT monitor 2 and TV monitor 3 that are connectable to the electronic apparatus, and LCD monitor 4). The power-off execution unit 25b turns off the power to a display device, among the display devices for which the wait time has been set by the setting unit 25a, if a continuous time of a state in which connection/disconnection of each display device is unchanged and no operation is effected by an input device reaches the wait time set for the display device.

On the screen provided by the setting unit 25a, the user can individually designate the application/non-application of automatic power-off and can set a wait time for each of the display devices.

Regardless of the display state of the mouse pointer on the screen, and regardless of the presence/absence of an active window on the screen, the power-off execution unit 25b monitors whether the above-mentioned continuous time reaches the wait time with respect to each of the display devices.

The power saving management unit 25 transmits/receives, when necessary, information relating to each display device to/from the system BIOS 24. For example, at regular time intervals, the bit indicative of the current setting information of each display device is “pooled” on the system BIOS 24 side. The power saving management unit 25 can acquire, via the OS 21, information on the display device that is retained in the system BIOS 24. Thereby, consistency in data can be kept between the system BIOS 24 and power saving management unit 25.

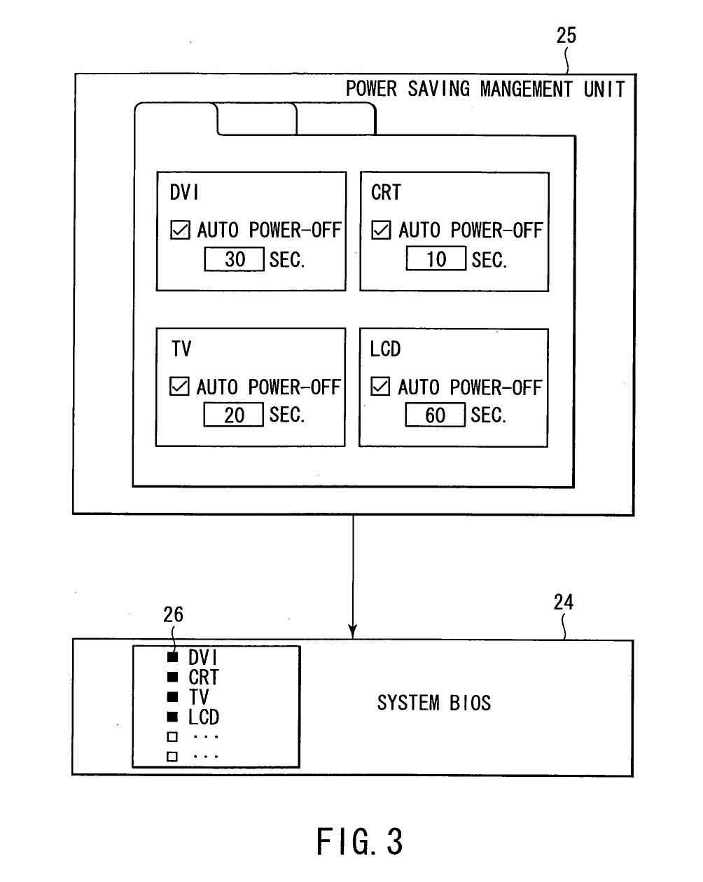

Referring now to FIG. 3, a description is given of the information that is handled by the power saving management unit 25 and system BIOS 24.

The power saving management unit 25 can display a setting screen, through which the user can designate application/non-application of automatic power-off by a check mark. If the user designates application of automatic power-off, then the wait time for turning off the power to the associated display device is to be designated.

On the other hand, the system BIOS 24 has bits 26 corresponding to the respective devices (including display devices 1 to 4). This makes it possible to recognize the state of each device that is connected to the electronic apparatus.

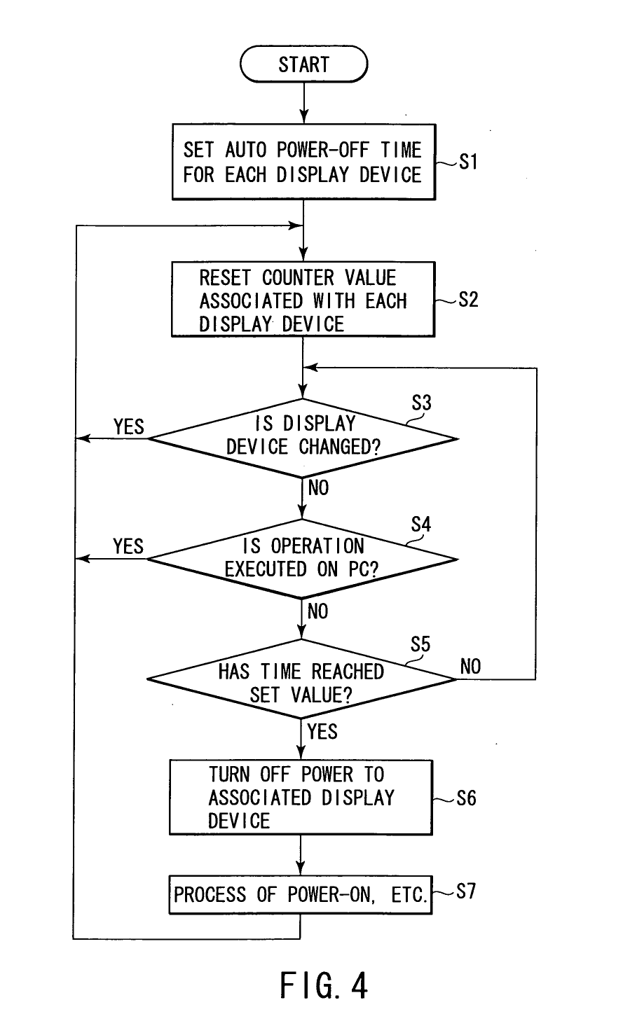

Next, referring to a flow chart of FIG. 4, the operation of the power saving management unit 25 is described.

In accordance with the user's input operation on the setting screen, a wait time for turning off the power to each display device, which is connected to the electronic apparatus, is individually set (step S1).

The counter value associated with each display device is reset, and time-counting is started (step S2).

At regular time intervals, it is checked whether the connection/disconnection state of each display device is changed, and whether an input operation by an input device is effected on the electronic apparatus (steps S3, S4). If YES in step S3 or S4, the process is repeated from step S2. If NO in step S3 or S4, it is determined whether the counter value reaches a set value (i.e., wait time set for a certain display device) (step S5). If the counter value reaches the set value, the power to the associated display device is turned off (step S6).

Subsequently, if the user executes an action such as an input operation, the power to the associated display device is turned on (step S7) and the process from step S2 is repeated.

According to the present embodiment, such flexible setting, as described below, can be effected: a short wait time is set for a display device with a high power consumption, and a long wait time is set for a display device with a low power consumption. Furthermore, since the transition of the power mode is not affected by the display condition of the mouse pointer or active window, the user can enjoy good convenience. This embodiment is effective for such configuration that the same data is simultaneously displayed on a plurality of display devices.

As has been described above in detail, according to the present invention, the user can individually set the wait time for turning off the power to each display device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus capable of displaying same data on a plurality of display devices, comprising:
a setting unit configured to individually set on a setting screen a wait time for turning off power to each of the plurality of display devices; and
a power-off execution unit configured to turn off power to a display device, among the plurality of display devices, if a continuous time of a state in which connection/disconnection of each display device is unchanged reaches the wait time set for the display device.

2. The electronic apparatus according to claim 1, wherein the continuous time includes a continuous time of a state in which connection/disconnection of each display device is unchanged and no operation is effected by an input device.

3. The electronic apparatus according to claim 1, wherein the power-off execution unit monitors whether the continuous time reaches the wait time with respect to each of the plurality of display devices, regardless of a display state of a mouse pointer on a screen.

4. The electronic apparatus according to claim 1, wherein the power-off execution unit monitors whether the continuous time reaches the wait time with respect to each of the plurality of display devices, regardless of presence/absence of an active window on a screen.

5. The electronic apparatus according to claim 1, wherein the setting unit enables designation of application/non-application of automatic power-off and designation of the wait time on the setting screen with respect to each of the plurality of display devices.

6. The electronic apparatus according to claim 1, wherein the setting unit and the power-off execution unit are realized by a power saving management program which is managed under an OS.

7. The electronic apparatus according to claim 6, further comprising a BIOS which stores information relating to devices connected to the electronic apparatus,
wherein the power saving management program transmits/receives information relating to each of the plurality of display devices to/from the BIOS.

8. A display device power management method applied to an electronic apparatus capable of displaying same data on a plurality of display devices, the method comprising:
enabling individual setting, on a setting screen, of a wait time for turning off power to each of the plurality of display devices; and
turning off power to a display device, among the plurality of display devices, if a continuous time of a state in which connection/disconnection of each display device is unchanged reaches the wait time set for the display device.

9. The display device power management method according to claim 8, wherein the continuous time includes a continuous time of a state in which connection/disconnection of each display device is unchanged and no operation is effected by an input device.

10. The display device power management method according to claim 8, wherein it is monitored whether the continuous time reaches the wait time with respect to each of the plurality of display devices, regardless of a display state of a mouse pointer on a screen.

11. The display device power management method according to claim 8, wherein it is monitored whether the continuous time reaches the wait time with respect to each of the plurality of display devices, regardless of presence/absence of an active window on a screen.

12. The display device power management method according to claim 8, wherein enabling the individual setting includes enabling designation of application/non-application of automatic power-off and designation of the wait time on the setting screen with respect to each of the plurality of display devices.

13. The display device power management method according to claim 8, wherein enabling the individual setting and turning off the power are executed by a power saving management program which is managed under an OS.

14. The display device power management method according to claim 13, wherein information relating to devices connected to the electronic apparatus is stored in a BIOS, and information relating to each of the plurality of display devices is transmitted/received between the power saving management program and the BIOS.
